(19) United States
(12) Patent Application Publication
(10) Pub. No.: US 2009/0019431 A1
(43) Pub. Date: Jan. 15, 2009

(54) OPTIMISED COMPILATION METHOD DURING CONDITIONAL BRANCHING

(75) Inventors: Tomson George, Kerala (IN); Bijo Thomas, Kerala (IN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/281,371

(22) PCT Filed: Feb. 24, 2007
(86) PCT No.: PCT/IB2007/050594

§ 371 Date: Sep. 2, 2008

Related U.S. Application Data
(60) Provisional application No. 60/778,835, filed on Mar. 2, 2006.

(51) Int. Cl. G06F 9/45

(52) U.S. Cl. 717/151

(57) ABSTRACT

The present invention discloses a compilation method of a program code in a digital device in a profile driven compilation. An approach for optimizing the execution of program code by providing additional intelligence to the compiler is provided, where the compiler decides whether to have single decision tree with guarded operations or multiple decision trees. The method of this invention is helpful, in reducing the overhead of conditional code branching to have an optimised program code, both in compiler driven optimisations and in manual optimisations by the programmer.

This invention generally relates to computer systems, and more specifically relates to compilers that generate executable program code for computer systems.

Since the dawn of the computer age, computer systems have evolved into extremely sophisticated devices, and computer systems may be found in many different settings. Dramatic advances in both hardware and software (e.g., computer programs) have drastically improved the performance of computer systems. Modern software has become very complex when compared to early computer programs. The execution time (and hence, performance) of a computer program is very closely related to the number of instructions that are executed as the computer program runs. Thus, as the size and complexity of computer programs increase, the execution time of the computer program increases as well.

Unlike early computer programs, modern computer programs are typically written in a high-level language that is easy to understand by a human programmer. Special software tools known as compilers take the human-readable form of a computer program, known as “source code”, and convert it into “machine code” or “object code” instructions that may be executed by a computer system. Because a compiler generates the stream of machine code instructions that are eventually executed on a computer system, the manner in which the compiler converts the source code to object code affects the execution time of the computer program code.

The execution time of a computer program, especially complex computer programs, is a function of the arrangement and type of instructions within the computer program. Loops affect the execution time of a computer program. If a computer program contains many loops, or contains any loops that are executed a relatively large number of times, the time spent for executing loops will significantly impact the execution time of a computer program.

An essential element for performance in VLIW architectures is the instruction scheduler of the compiler. The instruction scheduler is responsible for translating the sequential code produced by the core compiler into very long instruction word (VLIW) instructions each containing independent operations that are issued in parallel by the VLIW. Instruction schedulers operate on basic blocks termed as scheduling units. Decision trees and guarded decision trees are examples of scheduling units.

In order to optimize the performance of modern computer programs, profilers have been developed to predict and/or measure the run-time performance of a computer program. Profilers typically generate profile data that estimates how often different portions of the computer program are executed. Using profile data, an optimizer (such as an optimizing compiler) may make decisions to optimize loops in a computer program in order to improve the execution speed of the computer program.

Patent application number WO2003003195A1 discloses a profile driven compilation method which allows compiler to make intelligent trade-off decisions. It is been deployed in compilers of very long instruction word (VLIW) processors for predicting the branch target of a program. However, in these known methods the compiler needs to be guided for doing the optimal selection between guarded operations or a dedicated decision tree when a conditional execution is required in the program code. Hence, there exists an unsatisfied need for an improved compilation method of deciding between guarded operations or a decision tree when a conditional execution is required in the program code.

The present invention discloses a compilation method of a program code in a digital device in a profile driven compilation. An approach for optimizing the execution of program code by providing additional intelligence to the compiler is provided. The present invention provides an approach for conditional branching, which is based on the information provided to the compiler to either use guarding instructions or a separate decision tree. Sections of the code, which are called ‘hot spots’, are identified in a first compile-run (compile-execute) stage of profile driven compilation, and an overhead estimation is carried out to determine whether to have an additional decision tree or guarded operation on the identified conditional code branches. This information will be provided as an input to the last stage of the profile-driven compilation

A preliminary compilation stage of the profile driven compilation is carried out to identify the different sections of the program code. The main code and branch codes are identified at this stage. The branch code load (BCLD) and increased main code load (IMCLD) are also determined where BCLD is defined as the number of very long instruction words (VLIW) including the jump instructions in the branch codes. The IMCLD is defined as the additional load created due to the introduction of guarding operations for incorporating the branch code into the decision tree corresponding to the main loop. Upon estimating the aforementioned parameters, the frequency of execution of branch codes (NBE) as well as the frequency of execution of main codes (NME) is also estimated during the run (execution) stage of the profile driven compilation. If the probability of executing the branch code is low, then the corresponding processing load, where the processing load of the branch code is determined by taking the product of BCLD and NBE, will also be low. If the branch code processing load is less than a threshold, then the additional processing load created due to a separate decision tree for branching is less compared to the load created by using single decision tree with guarding. The threshold limit is determined by taking the product of IMCLD and NME.

The values of NBE and NME are fed into the compiler after first run. So the compiler makes a wise decision whether to have single decision tree or multiple decision trees for hot spots in the program code. A hot spot is defined as the different sections of the program code which account for considerable amount of processing load and hence are suitable candidates for optimisation. After identifying the hot spots in the program which have conditional code, the compiler has to verify the aforementioned condition in the profile driven compilation to make the decision.

In an embodiment of the present invention, the program code has a main code and a branch code and the compiler decides the instruction scheduling unit for the main code and the branch code as a single decision tree using guarded operations if the processing load of executing the branch code is less than a threshold limit. If the processing load of executing the branch code is greater than a threshold limit, the compiler decides the instruction scheduling units for the main code and the branch code as two separate decision trees in which case the branch code has a separate decision tree.

One object of the present invention is to select optimally between guarded operations or a dedicated decision tree when a conditional execution is required in the program code.

Another object of the present invention is to help the programmer to have an optimized program code by doing manual optimization.

Another object of the present invention is to reduce the overhead of conditional code branching in a program code.

The above summary of the present invention is not intended to describe each disclosed embodiment of the present invention. The figures and detailed description that follow provide additional aspects of the present invention.

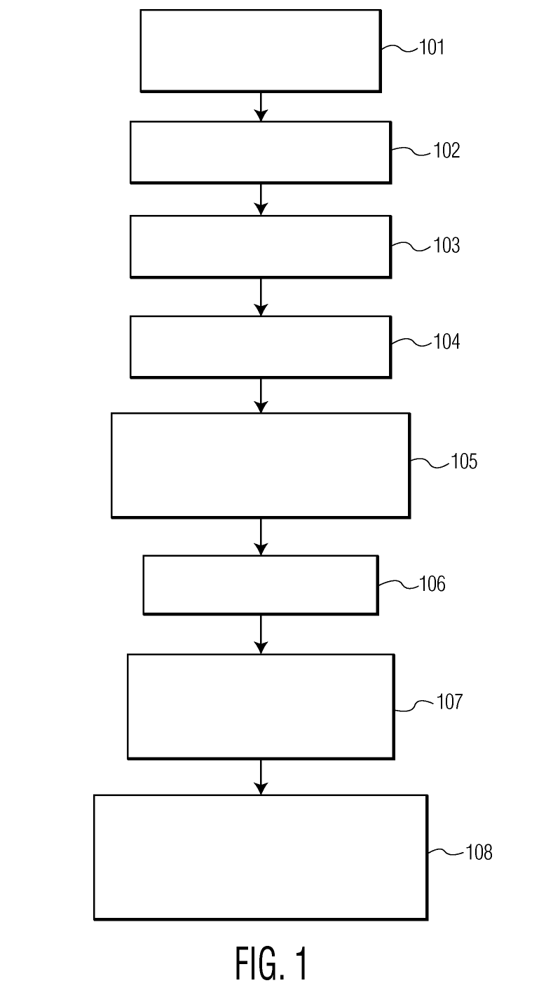

FIG. 1 illustrates the compilation method of a program code in a digital device, in a profile driven compilation.

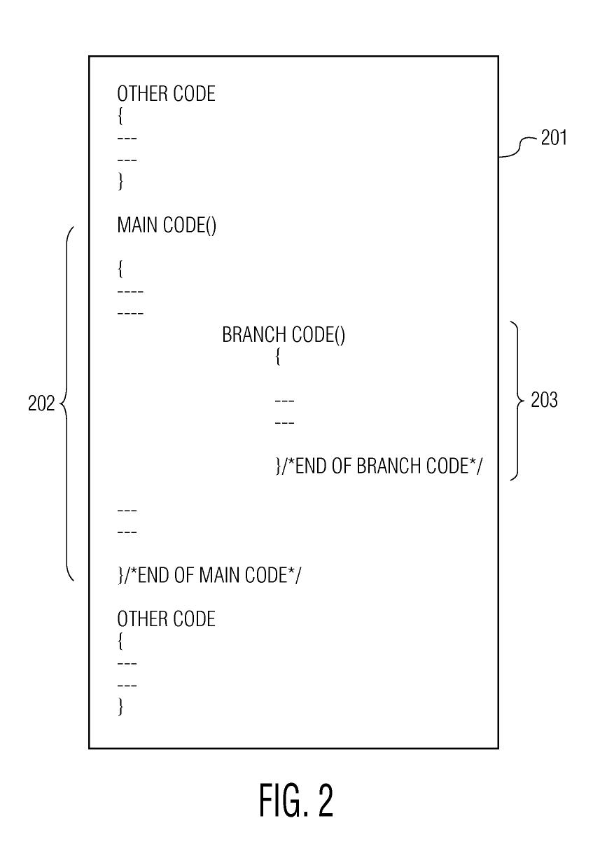

FIG. 2 illustrates the structure of the program source code which contains a main code section and a branch code section.

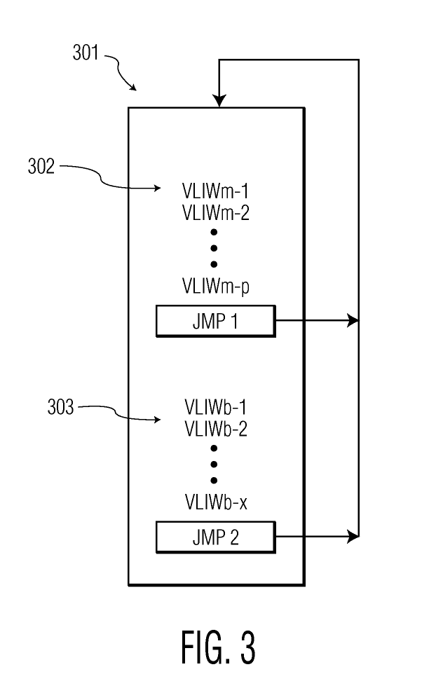

FIG. 3 illustrates the structure of the scheduling units of a program code where the branch code and main code belong to the same decision tree.

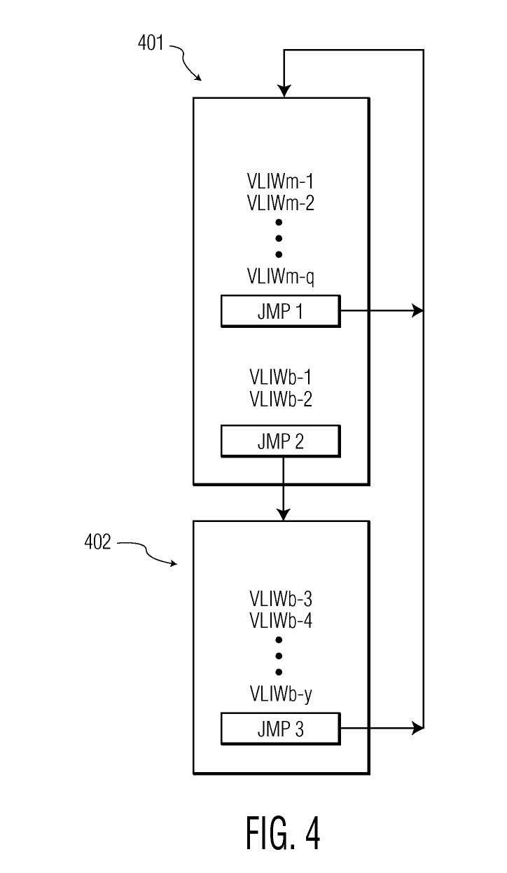

FIG. 4 illustrates the structure of the scheduling units of a program code, where the branch code and the main code belong to separate decision trees.

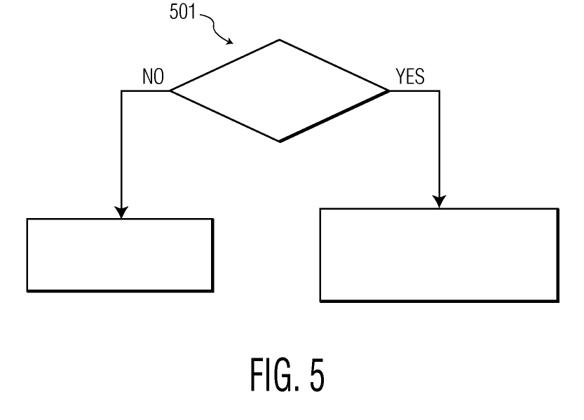

FIG. 5 illustrates the decision block representing the condition to be verified for compiler to decide whether to have single decision tree or multiple decision trees for the identified sections in the program code.

The present invention provides a method for optimizing the execution of program code by providing additional intelligence to the compiler. In the following description, numerous specific details are set forth in order to provide a more thorough understanding of the present invention. However, it will be apparent to one skilled in the art that the present invention may be practiced without these specific details. In other instances, well-known features have not been described in detail in order to avoid obscuring the present invention.

FIG. 1 illustrates the compilation method of a program code in a digital device, in a profile driven compilation. A preliminary compilation of the program code is executed for selecting the optimal scheme during the compilation of the program code 101. In this preliminary compilation the different sections of the program code are identified by the compiler. The compiler then identifies the main code and the branch codes in the program code 102, 103.

Upon the execution of the preliminary compilation stage, the number of very long instruction words (VLIW) including the jump instructions in the branch codes is determined. This number of VLIW, including the jump instructions, is referred to as branch code load (BCLD) 104. The frequency of execution of the branch codes during the execution of the preliminary compilation (NBE) and the frequency of execution of the main code during the execution of the preliminary compilation (NME) are determined 105 and 107. The increased main code load (IMCLD), which is the additional load created by using a single decision tree for the guarding operation, is also determined 106.

A condition has to be verified so that the compiler can make a wise decision whether to have single decision tree or multiple decision trees for the identified sections in the program code. The condition is explained below. A threshold limit is determined by taking the product of IMCLD and NME. If the probability of execution of the branch code is low, then the corresponding total processing load (hereinafter termed as ‘processing load’) of the branch code will also be low. The processing load of execution of the branch code is determined by taking the product of BCLD and NBE. If the processing load of executing the branch code is less than a threshold, then the additional load created due to a separate decision tree for branching is less compared to the load created by using single decision tree with guarding 108.

This condition is applied in compile-run-recompile scenario where NBE and NME could be an input to the compiler after first run. So the compiler can make a wise decision whether to have single decision tree or multiple decision trees for the identified sections in the program code. After identifying these sections in the program code, the compiler has to verify the above-mentioned condition in the profile driven compilation to make the decision.

FIG. 2 illustrates the structure of a typical program source code 201. This program source code 201 contains a main code section 202 and a branch code section 203. The branch code section 203 is a conditional code section in the main code section 202. During compilation, the instruction scheduler of the compiler have options including (i) form a single decision tree for the entire code in the “main code” section 202 including the “branch_code” 203 using guarding operations for the branch code 203 (ii) form a separate decision tree for the “branch_code” 203 other than the “main code” decision tree.

FIG. 3 illustrates the structure of the scheduling units in a program code 201 (as in FIG. 2) where the branch code and main code belong to the same decision tree 301. This figure relates to the case where the branch code 303 (corresponding to the branch code 203 in the source code 201 as in FIG. 2) or conditional code section is considered as a guarded operation, where the branch code section 303 and the main code section 302 (corresponding to the main code 202 in the source code as in FIG. 2) belong to the same decision tree 301. The branch code 303 or conditional code section mainly contains “IF THEN” and “IF ELSE” conditional statements. The VLIW instructions VLIWm and VLIWb in FIG. 2 are defined as follows. VLIWm is an abbreviated form for the VLIW instructions in the main code 302 and VLIWb is an abbreviated form for the VLIW instructions in the branch code 303.

FIG. 4 illustrates the structure of the scheduling units of a program code, where the branch code is separated from the main decision tree 401 (corresponding to the main code 202 in the source code 201 as in FIG. 2). I.e. the main code and branch code belong to separate decision trees 401 and 402 respectively. This figure relates to the case where the program code has a main code and a branch code and the compiler decides the instruction scheduling units for the main code and the branch code as two separate decision trees in which case the branch code has a separate decision tree 402. The branch code 402 (corresponding to the branch code 203 in the source code 201 as in FIG. 2) or conditional code section mainly contains “IF THEN” and “IF ELSE” conditional statements. The VLIW instructions VLIWm and VLIWb in FIG. 4 are defined as follows. VLIWm is an abbreviated form for the VLIW instructions in the main code 401 and VLIWb is an abbreviated form for the VLIW instructions in the branch code 402.

When the compiler tries to accommodate the branch code 203 in one decision tree (as in FIG. 3), then it has to execute some guarded operation which will normally increase the number of VLIW instructions in the main loop i.e. “VLIWm”. This implies that the number of VLIW instructions in the main code 201 (as in FIG. 2) when the branch code 203 and main code 202 belong to the same decision tree (as in FIG. 3) is greater than the number of VLIW instructions in the main code 401 (as in FIG. 4) when a separate decision tree is assigned to the main code 202 and branch code 203 during compilation (as in FIG. 4). This contributes to the increased main code load (IMCLD).

FIG. 5 illustrates the decision block representing the condition to be verified for compiler to decide whether to have single decision tree or multiple decision trees for the identified sections in the program code 501.

The compiler decides whether to have single decision tree or multiple decision trees by using the following condition.

If BCLD*NBE<IMCLD*NME, then go for two different trees for the main code and branch code.
If BCLD*NBE>IMCLD*NME, then go for single decision tree (with guarded operation).

If the processing load of executing the branch code is less than a threshold, then the additional load created due to a separate decision tree for branching is less compared to the load created by using single decision tree with guarding. In this case it will be logical for the compiler to create a new decision tree for the branch code.

What is claimed is:

1. A compilation method of a program code in a digital device, wherein said program code comprises a main code and a branch code, in a profile driven compilation, comprising the steps of:
determining a branch code load of the branch code, wherein said branch code load comprises a number of very long instruction words, wherein the very long instruction words comprises jump instructions in the branch codes;
determining a frequency of execution of the branch code during the execution of the preliminary compilation, wherein said preliminary compilation is first stage of said profile driven compilation;
determining an increased main code load, wherein said increased main code load comprises an additional load created by using a single decision tree with guarding operation;
determining a frequency of execution of said main code during execution of the preliminary compilation; and
deciding whether the processing load of executing the branch code is less than a threshold limit and, if so, creating a separate decision tree for the branch code,
deciding whether the processing load of executing the branch code is greater than a threshold limit and, if so, using guarding operations to incorporate the branch code as part of the decision tree of the main code.

2. The method of claim 1, wherein said processing load of executing the branch code is determined by a product of the branch code load and said frequency of execution of the branch code of the preliminary compilation

3. The method of claim 1, whereby a compiler deciding between guarded operations or a separate decision tree for the execution of the branch code.

4. The method of claim 1, wherein said threshold limit is determined by a product of the increased main code load and the frequency of execution of the main code during preliminary compilation.

5. The method of claim 1, wherein the branch code comprises conditional instructions in the program code.

6. The method of claim 1, wherein said digital device comprises a computer and the program code comprises a computer program code.

7. The method of claim 1, wherein the frequency of execution of the branch code and the frequency of execution of the main code is fed into a compiler after an execution of the preliminary compilation.

8. The method of claim 1, wherein said method is applied to a compiler chain of a plurality of very long instruction word processors.
